(19) United States
(12) Patent Application Publication
(10) Pub. No.: US 2018/0103819 A1
(43) Pub. Date: Apr. 19, 2018

(54) EXTENSION/IDENTIFICATION APPARATUS AND METHOD OF USING SAME

(71) Applicant: Cedar Creek Cleaning Products, LLC, Mooresville, NC (US)

(72) Inventor: Mark Allen Hoyle, Winchester, VA (US)

(21) Appl. No.: 15/786,041

(22) Filed: Oct. 17, 2017

Related U.S. Application Data
(60) Provisional application No. 62/496,389, filed on Oct. 17, 2016.

(51) Int. Cl. A47L 13/42; A47L 13/20; G09F 3/00; B25G 1/10

(52) U.S. Cl. CPC A47L 13/42; A47L 13/20; G09F 2003/0208; B25G 1/10; G09F 3/0295

(57) ABSTRACT

An identification/extension system comprises a kit for marking an instrument with distinguishing indicia. The kit includes at least one substantially cylindrical elastic band having distinguishing indicia thereon, and a collar member adapted for releasable attachment to an instrument and having an inner surface and an outer surface. A recess is formed on the outer surface to receive the elastic band therein, such that the elastic band sits substantially flush with the outer surface of the collar member.

### CROSS REFERENCE TO RELATED APPLICATIONS

This application claims priority to U.S. Provisional Patent Application No. 62/496,389, filed Oct. 17, 2016, and which is incorporated by reference herein.

### TECHNICAL FIELD OF INVENTION

The present invention relates to cleaning implements and the like. One embodiment of the invention comprises a cleaning device comprising an apparatus adapted to facilitate extension of the cleaning device and provide indicia that can identify and distinguish the particular device from similar devices.

### BACKGROUND OF INVENTION

There is a need for a system by which particular tools, in particular cleaning instruments, can be identified and distinguished from other identical tools. Previous color coding attempts include coloring an entire handle of a tool, and installing plastic snap-on clips (known as “E” clips), which can be easily removed and lost.

### SUMMARY OF INVENTION

An object of the present invention is to provide a system for identifying and distinguishing an instrument, such as a cleaning apparatus. Another object of the invention is to provide an apparatus that allows for adjustable extension of the length of a tool, such as a cleaning apparatus. These and other objects of the invention can be achieved in various embodiments of the invention described herein.

One embodiment of the invention comprises a kit for marking an instrument with distinguishing indicia comprising at least one substantially cylindrical elastic band having distinguishing indicia thereon, and a collar member adapted for releasable attachment to an instrument and having an inner surface and an outer surface, wherein a recess is formed on the outer surface to receive the at least one elastic band therein, whereby the at least one elastic band sits substantially flush with the outer surface of the collar member.

According to another embodiment of the invention, an attachment member is adapted for attaching to the instrument and releasably attaching to the collar member.

According to another embodiment of the invention, a first plurality of threads is formed on the inner surface of the collar member, and a second plurality of threads adapted for complementary engagement with the first plurality of threads is formed on the outer surface of the attachment member. The collar member and the attachment member can be attached to each other by complementary engagement between the first plurality of threads and the second plurality of threads.

According to another embodiment of the invention, the distinguishing indicia can be a color, an alphanumeric character, and/or a graphic.

According to another embodiment of the invention, the kit includes a plurality of substantially cylindrical elastic bands, and each elastic band includes different distinguishing indicia.

According to another embodiment of the invention, the kit includes a plurality of substantially cylindrical elastic bands, and each elastic band is a different color.

According to another embodiment of the invention, the substantially cylindrical elastic band is comprised of thermoplastic elastomer rubber.

According to another embodiment of the invention, the kit includes an instrument, such as a cleaning device.

Another embodiment of the invention comprises an apparatus comprising a substantially cylindrical elongate handle member having an upper end and a base end opposite the upper end, an attachment member attached to the handle member, a collar member releasably attached to the attachment member, and a substantially cylindrical elastic band having distinguishing indicia thereon positioned within a recess formed on the outer surface of the collar member, wherein the elastic band sits substantially flush with the outer surface of the collar member.

According to another embodiment of the invention, the distinguishing indicia comprises a color, an alphanumeric character, and/or a graphic.

According to another embodiment of the invention, a cleaning device comprises a handle attached at the upper end of the handle member adapted for gripping by a hand of a user, and a cleaning head adapted for cleaning a floor surface attached at the base end of the handle member.

According to another embodiment of the invention, the collar member is hollow, the inner surface of the collar member is substantially frusto-conical, and a first plurality of threads is formed on the inner surface of the collar member. The attachment member includes a substantially cylindrical outer surface and a second plurality of threads adapted for complementary engagement with the first plurality of threads is formed on the outer surface of the attachment member, such that the collar member and the attachment member are attached to each other by complementary engagement between the first plurality of threads and the second plurality of threads.

According to another embodiment of the invention, the substantially cylindrical elongate handle member comprises a first rod telescopically positioned within a second rod and adapted for sliding movement within the first rod. The second rod has at least one aperture formed therein, and the attachment member includes a substantially cylindrical inner surface attached to the second rod and at least one prong section positioned through the aperture formed in the second rod and contacting the first rod. The inner surface of the collar member contacts and urges the prong section(s) of the attachment member to frictionally engage the first rod when the first plurality of threads on the collar member engages the second plurality of threads on the attachment member, such that the first rod cannot move within the second rod.

According to another embodiment of the invention, the length of the handle member is adjustable by disengaging the first plurality of threads on the collar member from the second plurality of threads on the attachment member, sliding the first rod to a different position within the second rod, and engaging the first plurality of threads on the collar member to the second plurality of threads on the attachment member.

According to another embodiment of the invention, the collar member comprises a substantially frusto-conical body.

Another embodiment of the invention comprises a kit comprising a substantially cylindrical elongate handle member having an upper end and a base end opposite the upper end, an attachment member attached to the handle member, a collar member, wherein at least a portion of the outer surface is releasably attached to the attachment member, and at least one indicia member adapted for releasable attachment to the collar member. The indicia member has distinguishing indicia thereon.

According to another embodiment of the invention, the attachment member comprises a body section and a flange section extending outwardly from the body section. The indicia member is positioned against the flange section when the indicia member is attached to the collar member and the collar member is attached to the attachment member.

According to another embodiment of the invention, the collar member has a substantially frusto-conical hollow body and a first plurality of threads is formed on the outer surface of the collar member. The indicia member comprises a first indicia member having a substantially cylindrical hollow body and a second plurality of threads adapted for complementary engagement with the first plurality of threads is formed on the inner surface of the first indicia member, whereby the collar member and the first indicia member can be releasably attached to each other by complementary engagement between the first plurality of threads and the second plurality of threads.

According to another embodiment of the invention, the kit includes a second indicia member adapted for releasable attachment to the collar member. The first indicia member and the second indicia member have different distinguishing indicia, and the first indicia member and the second indicia member can be interchangeably attached to the collar member.

Another embodiment of the invention comprises a method in which a plurality of color-coded collars is provided. Each color-coded collar can be releasably attached to a cleaning instrument, such as the elongate shaft of a mop. Each of the various colored collars can be selected and attached to the cleaning instrument. Different colors can be used to designate particular uses for the cleaning instrument, such as cleaning particular areas of a facility, using particular cleaning chemicals, and/or using the cleaning instrument by a particular housekeeper. The color-coded collars can have a threaded inner surface to engage a complementary threaded section positioned on the outer surface of the cleaning instrument shaft.

### BRIEF DESCRIPTION OF THE DRAWINGS

FIG. 1 is a perspective view of an apparatus according to a preferred embodiment of the invention;

FIG. 2 is another perspective view of the apparatus of FIG. 1;

FIG. 3 is a partial view of the apparatus of FIG. 1;

FIG. 4 is another partial view of the apparatus of FIG. 1;

FIG. 5 is another partial view of the apparatus of FIG. 1;

FIG. 6 is another partial view of the apparatus of FIG. 1;

FIG. 7 is a cross-sectional view taken along lines 7-7 in FIG. 6;

FIG. 8 is another partial view of the apparatus of FIG. 1;

FIG. 9 is another perspective view of the apparatus of FIG. 1;

FIG. 10 is another perspective view of the apparatus of FIG. 1;

FIG. 11 is a perspective view of an apparatus according to another preferred embodiment of the invention;

FIG. 12 is a partial view of the apparatus of FIG. 11;

FIG. 13 is another partial view of the apparatus of FIG. 11; and

FIG. 14 is another partial view of the apparatus of FIG. 11.

### DETAILED DESCRIPTION OF PREFERRED EMBODIMENTS OF INVENTION

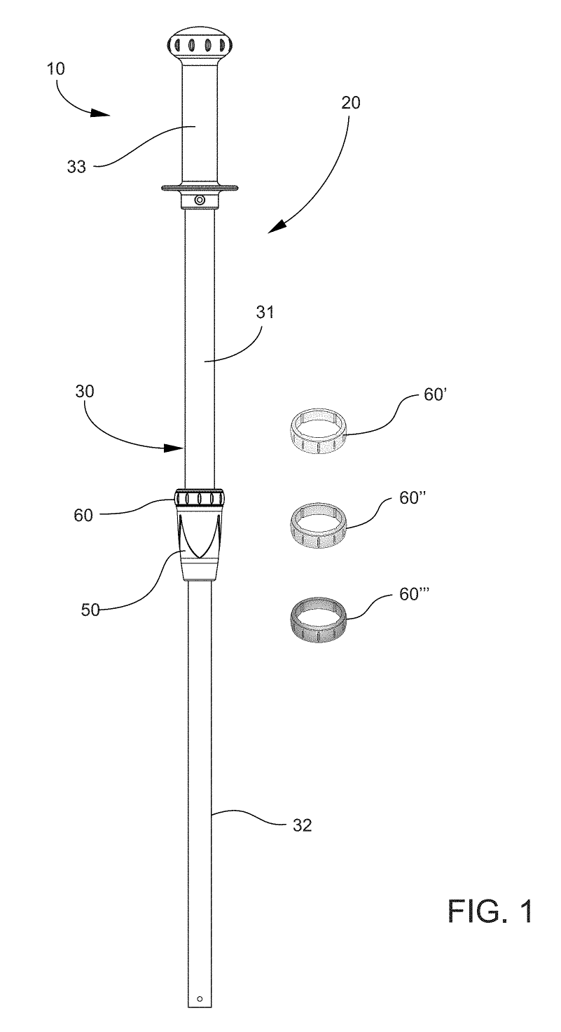

A kit according to a preferred embodiment of the invention is illustrated in FIGS. 1-10, and shown generally at reference numeral 10. The kit 10 comprises an instrument, such as a tool, and means for identifying and distinguishing the instrument from other similar instruments. The tool can be a cleaning apparatus, such as a mop. U.S. patent application Ser. No. 14/993,377, filed Jan. 12, 2016, is incorporated herein by reference. The kit 10 can also include means for adjusting the length of an instrument, such as a cleaning device.

As shown in FIG. 1, the kit 10 comprises a cleaning apparatus 20 comprising a substantially cylindrical elongate handle member 30. The handle member 30 can comprise a pair of telescoping elongate rods 31, 32. As shown in FIGS. 1, 9 and 10, a lower rod 32 is telescopically positioned within an upper rod 31. The lower rod 32 can slide within the upper rod 31, thereby changing the total length of the handle member 30. The rods 31, 32 can be made of plastic, aluminum, or other suitable material.

The upper rod 31 has a top end 31a, and a base end 31b opposite the top end 31a. The lower rod 32 has a top end 32a, and a base end 32b opposite the top end 32a. As shown in FIG. 1, a handle 33 for gripping by the hand of a user can be attached at the top end 31a of the upper rod 31. The handle 33 can generally be made of plastic or other suitable material. The handle 33 can be made by injection molding or other suitable process.

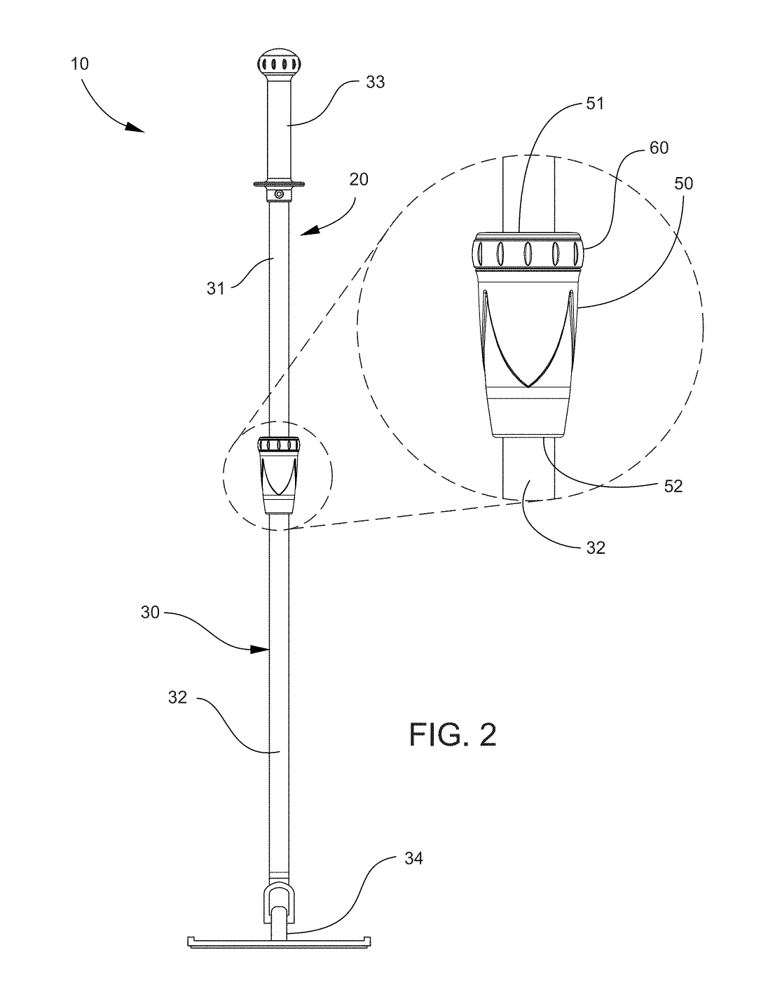

A cleaning head 34 adapted for cleaning a floor surface can be releasably attached to the base end 32b of the lower rod 32, as shown in FIG. 2. The cleaning head 34 can include a shaft section that is inserted into the base end 32b of the lower rod 32 and releasably held in place by a spring-loaded pin extending through a through hole 39 formed at the base end 32b of the lower rod 32. The cleaning head 34 can be easily removed by pushing the pin inward and sliding the lower rod 32 off of the cleaning head shaft.

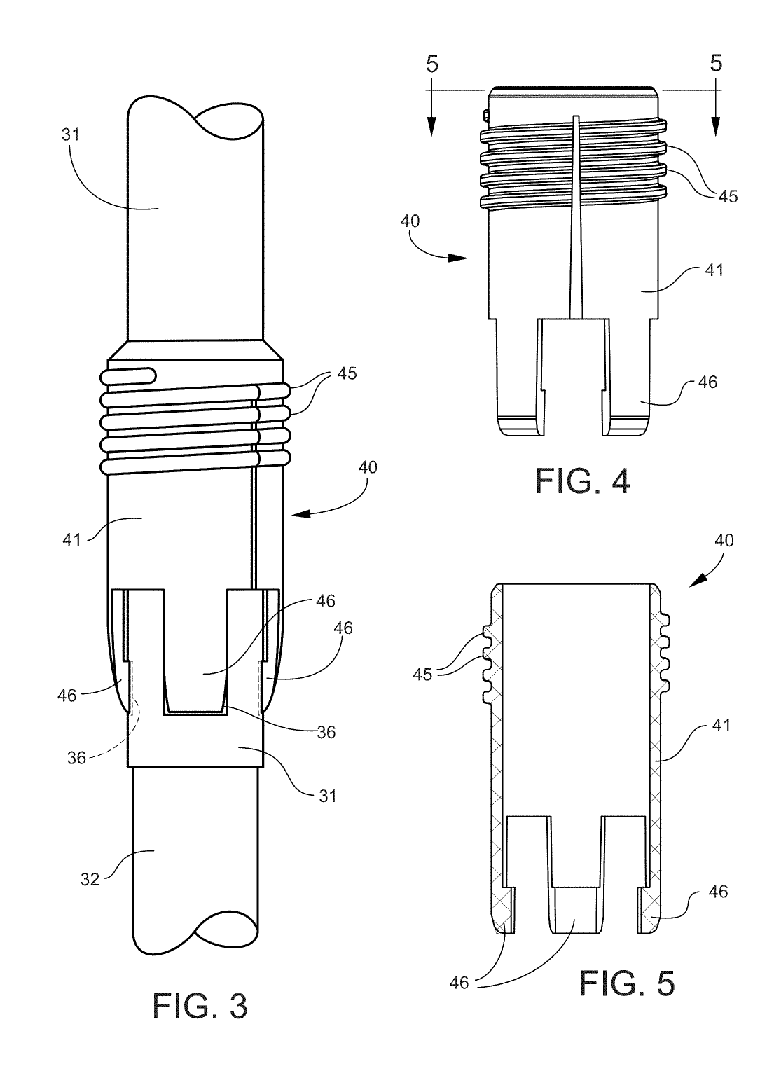

An attachment member 40 is positioned on the outer surface of the upper rod 31 proximate the base end 31b of the upper rod 31, as shown in FIG. 3. The attachment member 40 can be made of plastic or other suitable material. The attachment member 40 can be made by injection molding or other suitable process. The attachment member 40 can be attached to the upper rod 31 by an adhesive or other suitable attachment means. The attachment member 40 comprises a substantially cylindrical body section 41 that is attached to the outer surface of the upper rod 31, and a plurality of prongs 46 extending downwardly from the body section 41. A plurality of apertures 36 are formed in the upper rod 31 proximate the base end 31b of the upper rod 31. Each prong 46 includes a head section that extends through a corresponding aperture 36 in the upper rod 31, and contacts a portion of the lower rod 32 positioned within the upper rod 31. Preferably, the head of each prong 46 is the same shape as each aperture 36, such as square.

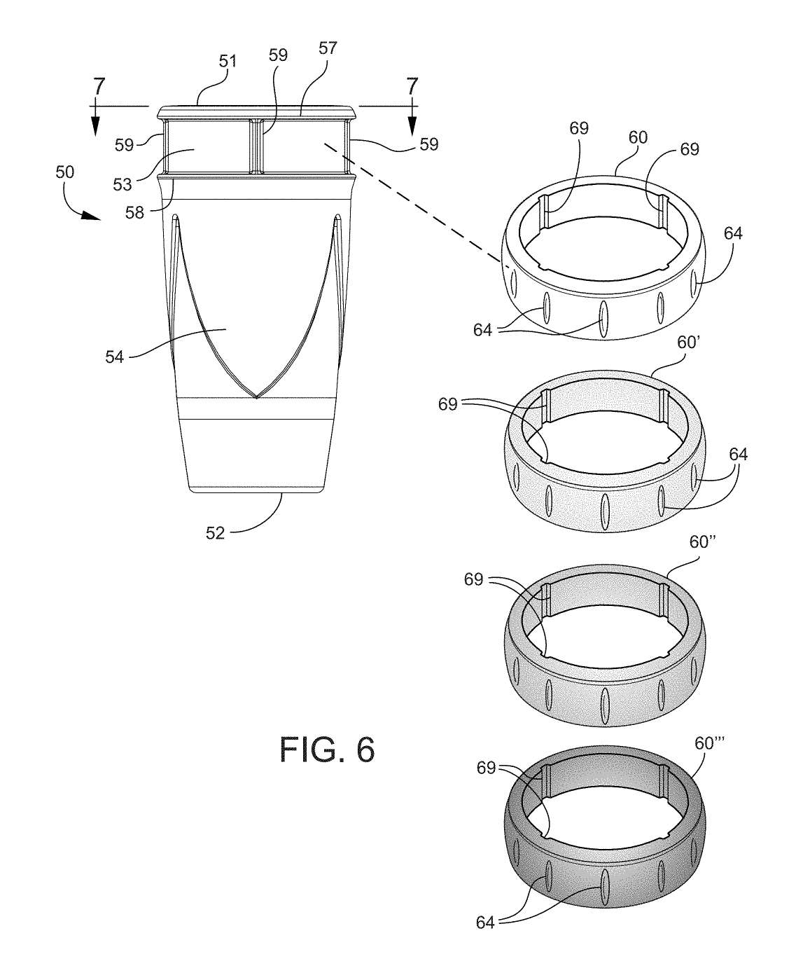

A collar member 50 is adapted to be releasably attached to the attachment member 40. As shown in FIGS. 6 and 8, the collar member 50 preferably comprises a hollow body defining a substantially frusto-conical outer surface 54 and a substantially frusto-conical inner surface 56. The collar member 50 defines first and second circular openings 51, 52. The upper opening 51 has a larger diameter than the base opening 52.

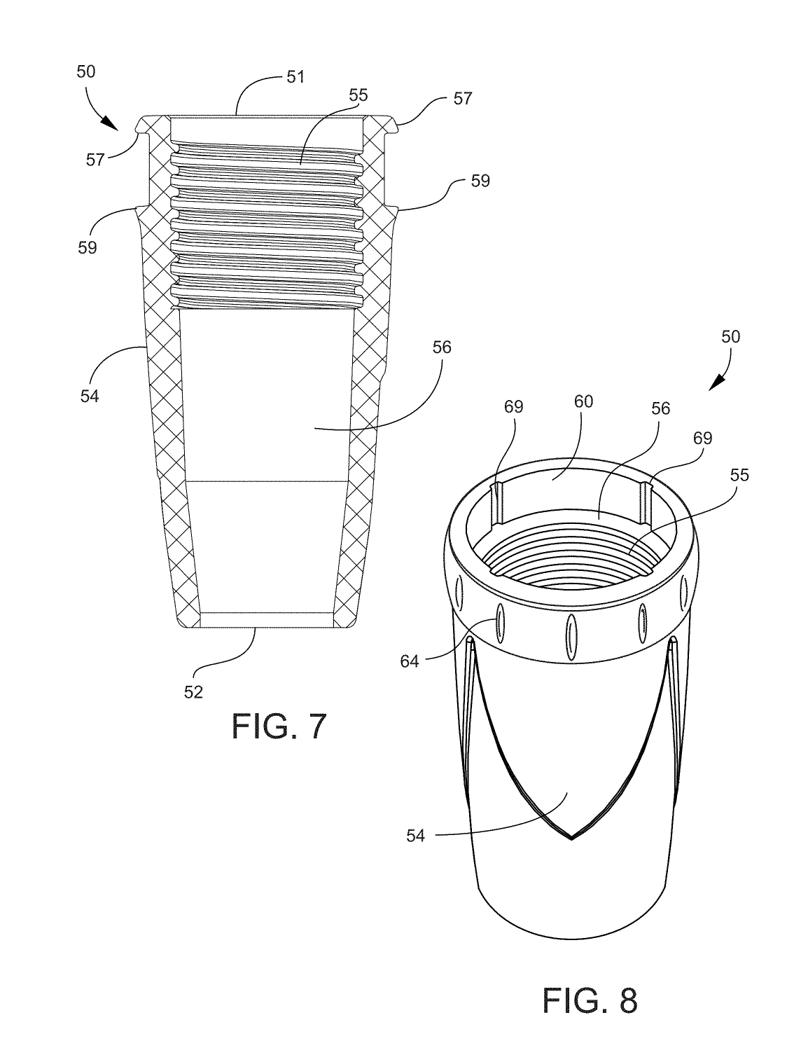

Threading 55 is formed on the inner surface 56 of the collar member 50 proximate the upper opening 51, as shown in FIGS. 7 and 8. Complementary threading 45 is formed on the outer surface of the attachment member 40 proximate the upper end of the attachment member body 41, as shown in FIGS. 3 and 4. The threading 55 of the collar member 50 can comprise female threading, and the threading 45 of the attachment member 40 can be male threading. Alternatively, the threading 55 of the collar member 50 can comprise male threading, and the threading 45 of the attachment member 40 can be female threading.

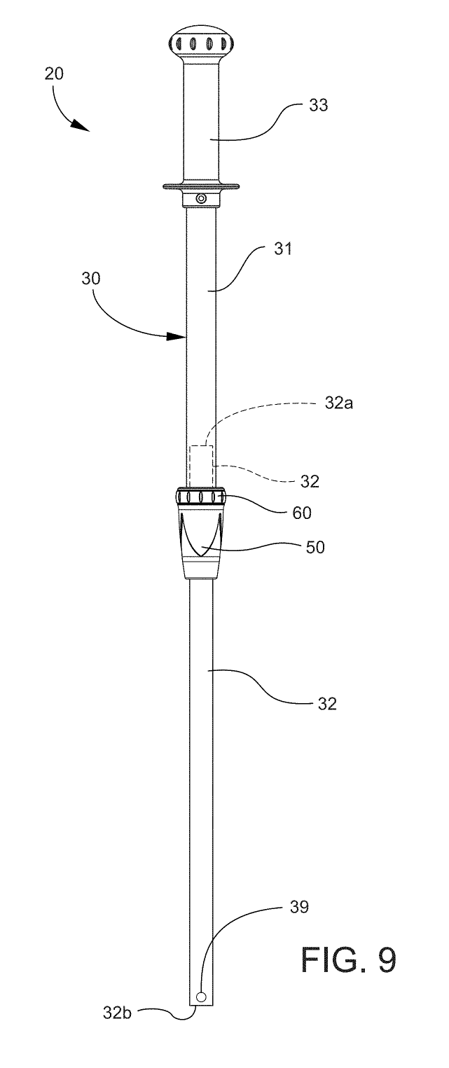

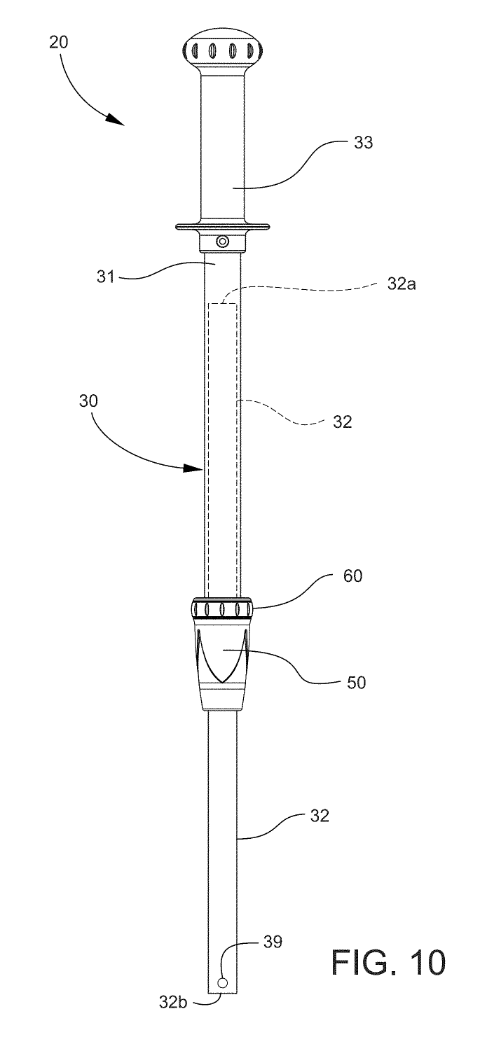

FIGS. 9 and 10 illustrate a method of using the kit 10 to adjust the length of the handle member 30, according to a preferred embodiment of the invention. The inner rod 32 is moved within the outer rod 31 until a desired overall length of the handle member 30 is attained. The handle member 30 is positioned through the collar member 50, with the inner rod 31 passing through the upper opening 51 of the collar member 50 first and then through the base opening 52, until the threading 55 of the collar member 50 contact the threading 45 of the attachment member 40. At that point, the collar 50 is rotated clockwise so that the collar threading 55 mates with and engages the attachment member threading 45. The collar 50 is turned clockwise until it is completely screwed onto the attachment member 40. As the collar 50 is screwed onto the attachment member 40, the collar 50 gradually moves upwardly on the attachment member 40, and the diameter of the portion of the frusto-conical inner surface 56 of the collar 50 that is in contact with the prongs 46 of the attachment member 40 gradually decreases, resulting gradually increasing force on the prongs 46. This increasing force pushes the prongs 46 through the outer rod apertures 36 and against the inner rod 32, causing the prongs 46 to frictionally engage the inner rod 32. The frictional engagement of the prongs 46 and the inner rod 32 securely holds the inner rod 32 in place at the desired position.

When it is desired to change the length of the handle member 30, the collar 50 is rotated counter-clockwise to unscrew the collar 50 from the attachment member 40. When the collar threads 55 are disengaged from the attachment member threads 45, the collar 50 is released from the attachment member 40 and can be slid off of the attachment member 40. When the collar 50 is removed from the attachment member 40, the prongs 46 of the attachment member 40 are no longer pushed against the inner rod 32. As such, the inner rod 32 is released from frictional engagement with the prongs 46, and can be freely moved within the outer rod 31, as illustrated in FIGS. 9 and 10. The inner rod 32 can be moved to a different position within the outer rod 31 to attain another desired length of the handle member 30. When the inner rod 32 is at the desired position within the outer rod 31, the collar 50 can be re-attached to the attachment member 40 to lock the inner rod 32 in place again.

An indicia member 60, having distinguishing indicia thereon, is releasably attached to the collar member 50. The distinguishing indicia can be color, alphanumeric characters, and/or graphics. Preferably, the indicia member 60 comprises a substantially cylindrical elastic band.

As shown in FIG. 6, the collar 50 includes a pair of outwardly extending flanges 57, 58 that define a recessed section 53 formed in the outer surface 54 of the collar 50, proximate the upper opening 51. The recess section 53 is sized and shaped to receive the elastic band 60 therein. As such, the band 60 sits substantially flush with the outer surface 54 of the collar 50, as shown in FIG. 2. The band 60 is made of thermoplastic elastomer rubber, or other suitable material providing an elasticity such that the band 60 securely grips the recess section 53 of the collar. In addition, the band 60 has a high coefficient of friction that helps the user grip the collar member 50 when tightening or loosening the collar 50 on the attachment member 40 (screwing the collar 50 on or off). A plurality of indentations 64 can be formed on the band 60 that further facilitate gripping of the collar 50. The band 60 is stretched over the flange 57 and positioned in the recess section 58 of the collar.

A plurality of outwardly extending ridges 59 can be formed in the recess section 58, as shown in FIG. 6. A plurality of complimentary channels 69 are formed in the inner surface of the band 60, as shown in FIG. 6. The channels 69 are sized and shaped to receive the collar ridges 59 when the band 60 is positioned in the recess section 53. Each collar ridge 59 registers with a complementary channel 69, which further secures the band 60 in the recess section 58 and prevents the band 60 from off the collar 50 unintentionally. Removal of the band 60 requires the band 60 to be stretched over one of the flanges 57, 58.

The band 60 does not clip on and cannot easily fall off. The user has to remove the locking collar 50 before the colored band 60 can be removed. Once the collar 50 is reinstalled and the handle 33 is attached to a mop head, the color band 60 cannot fall off, get knocked off, or get lost.

Preferably, the kit 10 includes a plurality of indicia bands 60, 60′, 60″, 60′″, as shown in FIG. 6. The bands 60, 60′, 60″, 60′″ have the same structure, but each band 60, 60′, 60″, 60′″ is a different color. As such, the bands 60, 60′, 60″, 60′″ are distinguishable from each other. For example, in one embodiment of the invention, band 60 can be green, band 60′ can be blue, band 60″ can be yellow, and band 60′″ can be red. Alternatively, each band 60, 60′, 60″, 60′″ can have different words, numbers, and/or graphics thereon to distinguish the bands 60, 60′, 60″, 60′″ from each other.

In a method of using the kit 10 according to a preferred embodiment of the invention, the various colored bands 60, 60′, 60″, 60′″ can be used to identify and designate the apparatus 20 for different purposes, such as cleaning different areas of a facility, using different cleaning chemicals/solvents with the apparatus, and/or using the apparatus by different users. For example, in one embodiment of the invention, each band 60, 60′, 60″, 60′″ can designate a specific area or floor in which the apparatus 20 is to be used. An apparatus 20 having a green band 60 can alert cleaning staff that the apparatus 20 is to be used only on the first floor. An apparatus 20 having a blue band 60′ can alert staff that the apparatus 20 is to be used on the second floor. Yellow and red bands 60″, 60′″ can be used to designate use of on third and fourth floors, respectively. This can be particularly useful in facilities in which certain areas are exposed to particular allergens, such as peanuts and the like. By identifying each apparatus 20 with the appropriate color band 60, 60′, 60″, 60′″, cleaning personnel can know which cleaning tools are to be used in particular areas, thereby minimizing incidents of cross contamination, in which an instrument that has been used in allergen contaminated areas is unintentionally brought into an area that is supposed to be clean and free of allergens. If the user wishes to change the designation of the apparatus 20 in order to use the apparatus 20 in a different area, the band 60 currently on the apparatus 20 can be removed and replaced with the appropriate one of the other bands 60′, 60″, 60′″.

In another embodiment of the invention, the various colored bands 60, 60′, 60″, 60′″ can be used to designate particular chemicals, solvents or other substances that are to be used with the apparatus 20. For example, a green band 60 can designate that the apparatus 20 is not be used with any solvent containing bleach, and a blue band 60′ can designate that another apparatus 20 is to be used bleach containing solvents. As such, it is made clear to cleaning personnel which instruments can be used with bleach and which ones are not, thereby avoiding unintended cross contamination.

In another embodiment of the invention, the various colored bands 60, 60′, 60″, 60′″ can be used to identify a particular apparatus 20 as belonging to a particular individual. For example, in a facility that is cleaned by four cleaning staff members with each member using one of a plurality of otherwise identical cleaning devices 20, each colored band 60, 60′, 60″, 60′″ can designate a particular staff member. The particular cleaning apparatus 20 that is to be used by a particular staff member can be marked using the particular one of the color bands 60, 60′, 60″, 60′″ designated for the particular staff member. As such, each staff member knows which cleaning device is theirs to use each day. This encourages the staff to be diligent and responsible in caring for and maintain their particular cleaning apparatus since they know they will be using the same apparatus every day.

In addition, the bands 60, 60′, 60″, 60′″ can be used to enhance the aesthetics of the apparatus 20. Each band 60, 60′, 60″, 60′″ can have a decorative graphic design, and a user selects a particular one of the bands band 60, 60′, 60″, 60′″, and the user selects a band 60, 60′, 60″, 60′″ based on aesthetic preference.

In an alternative embodiment of the invention, the kit 10 can include a plurality of collars 50, in which each collar 50 has a different colored band 60, 60′, 60″, 60′″ positioned thereon. As such, instead of using a plurality of indicia bands 60, 60′, 60″, 60′″ with a single collar 50 to identify a particular cleaning apparatus 20, a plurality of collars 50, each having a different colored band 60, 60′, 60″, 60′″, can be used to identify a particular cleaning apparatus 20. When it is desired to change the identification or designation of the cleaning apparatus 20, one collar 50 can be replaced on the attachment member 40 with another. In another embodiment of the invention, the kit 10 comprises a plurality of apparatuses 20.

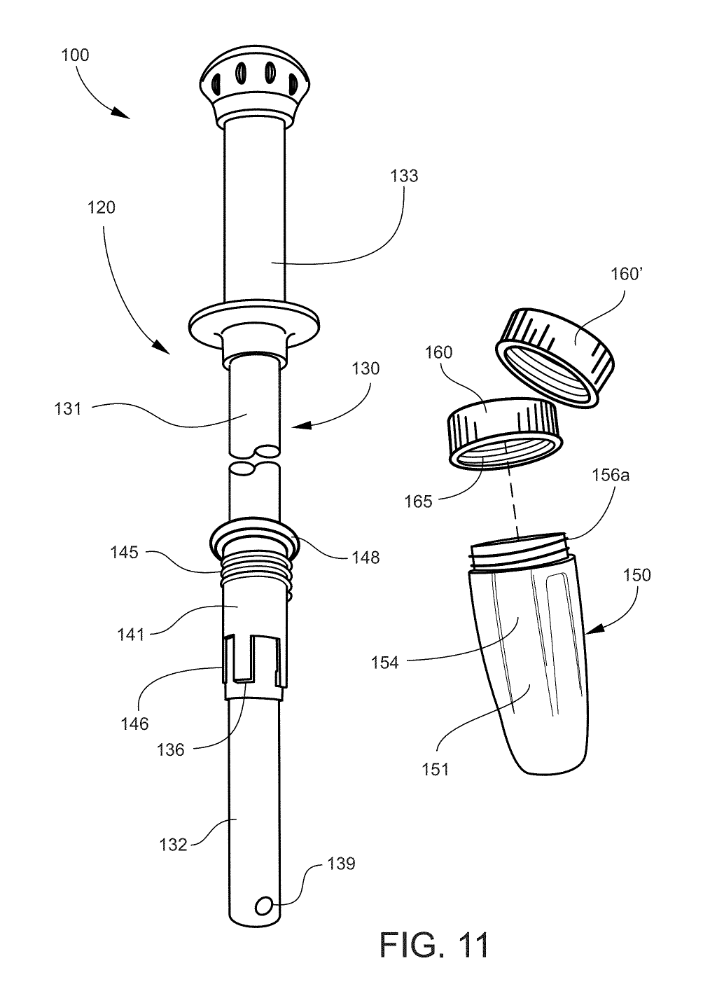

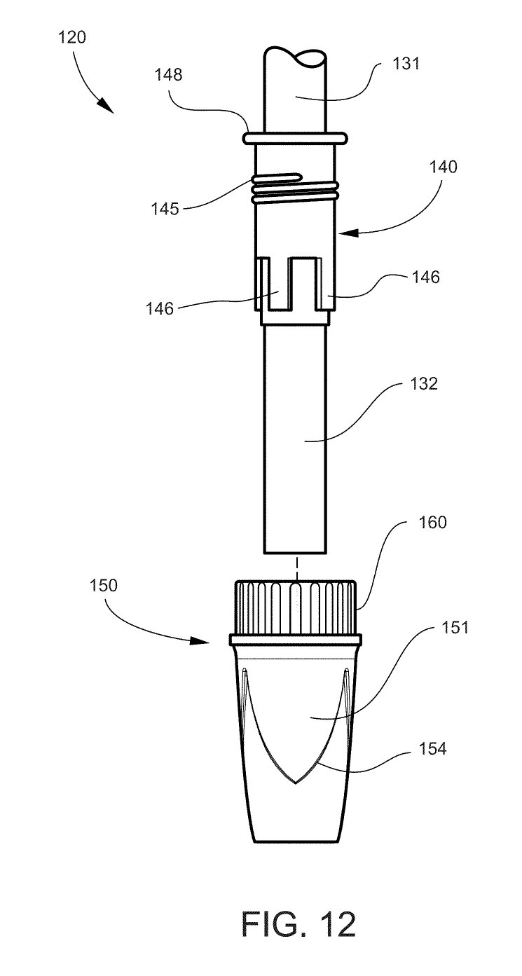

A kit according to another preferred embodiment of the invention is illustrated in FIGS. 11-14, and shown generally at reference numeral 100. The kit 100 comprises an instrument, such as a cleaning apparatus 120, comprising a substantially cylindrical elongate handle member 130. The handle member 30 can comprise a pair of telescoping elongate rods 131, 132. The lower rod 132 can be telescopically positioned within the upper rod 131. The lower rod 132 can slide within the upper rod 131, thereby changing the total length of the handle member 130. The rods 131, 132 can be made of plastic, aluminum, or other suitable material.

The upper rod 131 has a top end 1131a, and a base end 131b opposite the top end 131a. The lower rod 132 has a top end, and a base end opposite the top end. As shown in FIG. 11, a handle 133 for gripping by the hand of a user can be attached at the top end of the upper rod 131. The handle 133 can generally be made of plastic or other suitable material. The handle 133 can be made by injection molding or other suitable process.

A cleaning head adapted for cleaning a floor surface can be releasably attached to the base end of the lower rod 132. The cleaning head 34 can include a shaft section that is inserted into the base end of the lower rod 132 and releasably held in place by a spring-loaded pin extending through a through hole 139 formed at the base end of the lower rod 132. The cleaning head can be removed by pushing the pin inward and sliding the lower rod 132 off of the cleaning head shaft.

An attachment member 140 is positioned on the outer surface of the upper rod 131 proximate the base end of the upper rod 131. The attachment member 140 can be made of plastic or other suitable material. The attachment member 140 can be made by injection molding or other suitable process. The attachment member 140 can be attached to the upper rod 31 by an adhesive or other suitable attachment means.

The attachment member 140 comprises a substantially cylindrical body section 141 that is attached to the outer surface of the upper rod 131, and a plurality of prongs 146 extending downwardly from the body section 141. A plurality of apertures 136 are formed in the upper rod 131 proximate the base end of the upper rod 131. Each prong 146 includes a head section that extends through a corresponding aperture 136 in the upper rod 131, and contacts a portion of the lower rod 132 positioned within the upper rod 131. Preferably, the head of each prong 146 is the same shape as each aperture 136, such as square. A flange 148 extends outwardly from the attachment member body 141, as shown in FIG. 11.

The kit 100 includes a collar member 150 adapted to be releasably attached to the attachment member 140. The collar member 150 preferably comprises a hollow body 151 having a substantially frusto-conical outer surface 154 and a substantially frusto-conical inner surface 156. The collar member 150 defines an upper opening and a base opening. The upper opening has a larger diameter than the base opening. The collar body 151 can be made of plastic or other suitable material.

The collar 150 includes a substantially cylindrical top ring section 160 that is adapted for releasable attachment to upper end of the body section 151. The ring section 160 can be made of plastic or other suitable material. Threading 155a is formed on the outer surface of 154 of the collar body 151, and complementary threading 165 is formed on the inner surface of the ring section 160, as shown in FIG. 11. The collar body threading 155a can comprise female threading, and the ring section threading 165 can be male threading. The collar top section 160 is attached to the collar body 151 by rotating the top ring section 160 clockwise to screw the top section 160 onto the collar body section 151. The top ring section 160 can be removed from the collar body 151 by turning the ring 160 counterclockwise.

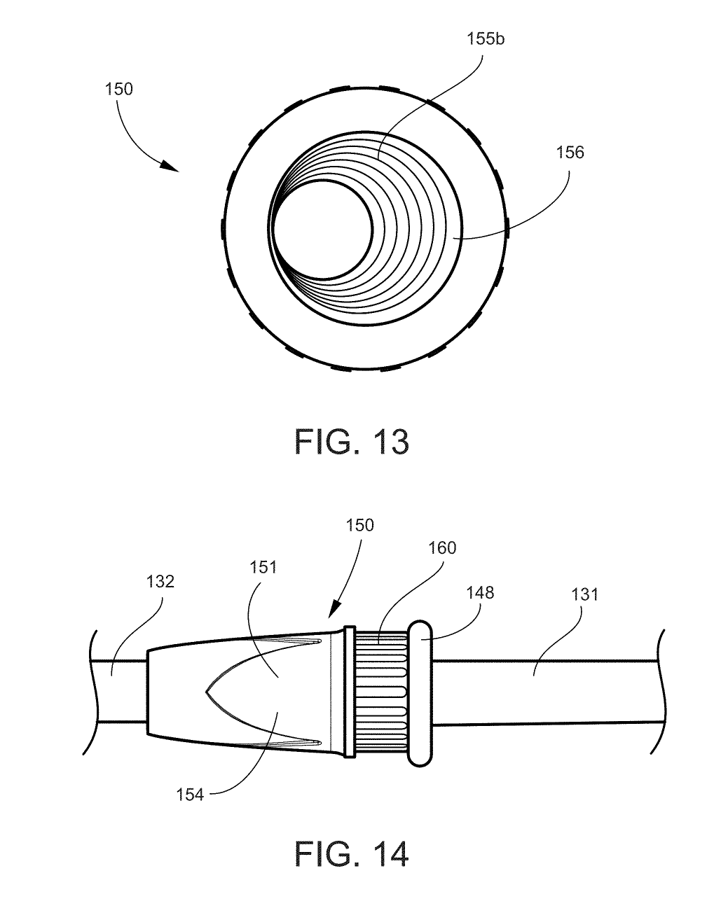

Threading 155b is formed on the inner surface 156 of the collar 150 proximate the upper end of the collar body 151, as shown in FIG. 13. Complementary threading 145 is formed on the outer surface of the attachment member 140 proximate the upper end of the attachment member body 141, as shown in FIG. 11. The threading 155b of the collar member 150 can comprise female threading, and the threading 145 of the attachment member 140 can be male threading. Alternatively, the threading 155b of the collar member 150 can comprise male threading, and the threading 145 of the attachment member 140 can be female threading.

In a method of using the kit 100 according to a preferred embodiment of the invention, the inner rod 132 is moved within the outer rod 131 until a desired overall length of the handle member 130 is attained. The handle member 130 is positioned through the collar member 150, with the inner rod 131 passing through the upper of the collar member 150 first and then through the base opening, until the threading 155b on the inner surface 154 of the collar member 150 contact the threading 145 of the attachment member 140. At that point, the collar 150 is rotated clockwise so that the collar threading 155b mates with and engages the attachment member threading 145. The collar 150 is turned clockwise until it is completely screwed onto the attachment member 140. As the collar 150 is screwed onto the attachment member 140, the collar 150 gradually moves upwardly on the attachment member 140, and the diameter of the portion of the frusto-conical inner surface 156 of the collar 150 that is in contact with the prongs 146 of the attachment member 140 gradually decreases, resulting in gradually increasing force on the prongs 146. This increasing force pushes the prongs 146 through the outer rod apertures 136 and against the inner rod 132, causing the prongs 146 to frictionally engage the inner rod 132. The frictional engagement of the prongs 146 and the inner rod 132 securely holds the inner rod 132 in place. When the collar 150 is completely screwed onto the attachment member 140, the top section 160 of the collar 150 sits tightly against the attachment member flange 148, which helps keep the collar 150 secured on the attachment member 140.

When it is desired to change the length of the handle member 130, the collar 150 is rotated counter-clockwise to unscrew the collar 150 from the attachment member 140. When the collar threads 155b are disengaged from the attachment member threads 145, the collar 150 is released from the attachment member 140 and can be slid off of the attachment member 140. When the collar 150 is removed from the attachment member 140, the prongs 146 of the attachment member 140 are no longer pushed against the inner rod 132. As such, the inner rod 132 is released from frictional engagement with the prongs 146, and can be freely moved within the outer rod 131. The inner rod 132 can be moved to a different position within the outer rod 1131 to attain another desired length of the handle member 130. When the inner rod 132 is at the desired position within the outer rod 131, the collar 150 can be re-attached to the attachment member 140 to lock the inner rod 132 in place again.

The top ring section 160 of the collar 150 includes distinguishing indicia, such as color, alphanumeric characters, and/or graphics. Preferably, the indicia member 60 comprises a substantially cylindrical elastic band.

Preferably, the kit 100 includes a plurality of indicia ring sections 160, 160′, as shown in FIG. 11. The top ring sections 160, 160′ have the same structure, but each top section 160, 160′ is a different color. As such, the rings 160, 160′ are distinguishable from each other. For example, in one embodiment of the invention, ring 160 can be green, and ring 160′ can be red. Alternatively, each ring 160, 160′ can have different words, numbers, and/or graphics thereon to distinguish the bands 160, 160′ from each other.

In a method of using the kit 100 according to a preferred embodiment of the invention, the various colored top sections 160, 160′ can be used to identify and designate the apparatus 120 for different purposes, such as cleaning different areas of a facility, using different cleaning chemicals/solvents with the apparatus, and/or using the apparatus by different users. For example, in one embodiment of the invention, each top 160, 160′ can designate a specific area or floor in which the apparatus 120 is to be used. An apparatus 120 having collar 150 with a green top section 160 can alert cleaning staff that the apparatus 120 is to be used only on the first floor. An apparatus 120 having collar 150 with a red top 160′ can alert staff that the apparatus 120 is to be used on the second floor. This can be particularly useful in facilities in which certain areas are exposed to particular allergens, such as peanuts and the like. By identifying each apparatus 120 with a collar 150 having the appropriate color top 160, 160′, cleaning personnel can know which cleaning tools are to be used in particular areas, thereby minimizing incidents of cross contamination, in which an instrument that has been used in allergen contaminated areas is unintentionally brought into an area that is supposed to be clean and free of allergens. If the user wishes to change the designation of the apparatus 120 in order to use the apparatus 120 in a different area, the top 160 currently on the apparatus 120 can be removed from the collar 150 and replaced with another top 160″.

In another embodiment of the invention, the various colored bands 160, 160′ tops can be used to designate particular chemicals, solvents or other substances that are to be used with the apparatus 120. For example, a green top 160 can designate that the apparatus 120 is not be used with any solvent containing bleach, and a red top 160′ can designate that another apparatus 120 is to be used with bleach containing solvents. As such, it is made clear to cleaning personnel which instruments can be used with bleach and which ones are not, thereby avoiding unintended cross contamination.

In another embodiment of the invention, the various colored top1s 160, 160′ can be used to identify a particular apparatus 120 as belonging to a particular individual. For example, in a facility that is cleaned by two cleaning staff members with each member using one of a pair of otherwise identical cleaning devices 120, each colored top 160, 160′ can designate a particular staff member. The particular cleaning apparatus 120 that is to be used by a particular staff member can be marked using the particular one of the color tops 160, 160′ designated for the particular staff member. As such, each staff member knows which cleaning device is theirs to use each day. This encourages the staff to be diligent and responsible in caring for and maintain their particular cleaning apparatus since they know they will be using the same apparatus every day.

In addition, the top sections 160, 160′ can be used to enhance the aesthetics of the apparatus 120. Each top 160, 160′ can have a decorative graphic design, and a user selects a particular one of the tops 160, 160′, and the user selects a top 160, 160′ based on aesthetic preference.

In an alternative embodiment of the invention, the kit 100 can include a plurality of collars 150, in which each collar 150 has a different colored top section 160, 160′ positioned thereon. When it is desired to change the identification or designation of the cleaning apparatus 120, one collar 150 can be replaced on the attachment member 140 with another. In another embodiment of the invention, the kit 100 comprises a plurality of apparatuses 20.

An extension/identification apparatus and method of using same are described above. Various changes can be made to the invention without departing from its scope. The foregoing description of embodiments of the invention are provided for the purpose of illustration only and not limitation—the invention being defined by the following claims and equivalents thereof.

What is claimed is:

1. A kit for marking an instrument with distinguishing indicia comprising:
(a) at least one substantially cylindrical elastic band having distinguishing indicia thereon; and
(b) a collar member adapted for releasable attachment to an instrument and having an inner surface and an outer surface, wherein a recess is formed on the outer surface to receive the at least one elastic band therein,
whereby the at least one elastic band sits substantially flush with the outer surface of the collar member.

2. The kit according to claim 1, further comprising an attachment member adapted for attaching to the instrument and releasably attaching to the collar member.

3. The kit according to claim 2, wherein a first plurality of threads is formed on the inner surface of the collar member, and a second plurality of threads adapted for complementary engagement with the first plurality of threads is formed on an outer surface of the attachment member, whereby the collar member and the attachment member can be attached to each other by complementary engagement between the first plurality of threads and the second plurality of threads.

4. The kit according to claim 1, wherein the distinguishing indicia comprises at least one selected from the group consisting of a color, an alphanumeric character, and a graphic.

5. The kit according to claim 4, wherein the at least one substantially cylindrical elastic band comprises a plurality of substantially cylindrical elastic bands, wherein each elastic band includes a different distinguishing indicia.

6. The kit according to claim 1, wherein the at least one substantially cylindrical elastic band comprises a plurality of substantially cylindrical elastic bands, wherein each elastic band is a different color.

7. The kit according to claim 1, wherein at least one substantially cylindrical elastic band is comprised of thermoplastic elastomer rubber.

8. The kit according to claim 1, further comprising the instrument, wherein the instrument comprises a cleaning device.

9. An apparatus comprising:
(a) a substantially cylindrical elongate handle member having an upper end and a base end opposite the upper end;
(b) an attachment member attached to the handle member;
(c) a collar member releasably attached to the attachment member and having an outer surface and an inner surface; and
(d) a substantially cylindrical elastic band having distinguishing indicia thereon positioned within a recess formed on the outer surface of the collar member, wherein the elastic band sits substantially flush with the outer surface of the collar member.

10. The apparatus according to claim 9, wherein the distinguishing indicia comprises at least one selected from the group consisting of a color, an alphanumeric character, and a graphic.

11. The apparatus according to claim 9, the apparatus comprising a cleaning device comprising:
(a) a handle attached at the upper end of the handle member adapted for gripping by a hand of a user; and
(b) a cleaning head adapted for cleaning a floor surface attached at the base end of the handle member.

12. The apparatus according to claim 9, wherein the collar member is hollow, the inner surface of the collar member is substantially frusto-conical, and a first plurality of threads is formed on the inner surface of the collar member, and further wherein the attachment member includes a substantially cylindrical outer surface and a second plurality of threads adapted for complementary engagement with the first plurality of threads is formed on the outer surface of the attachment member, whereby the collar member and the attachment member are attached to each other by complementary engagement between the first plurality of threads and the second plurality of threads.

13. The apparatus according to claim 12, wherein the substantially cylindrical elongate handle member comprises a first rod telescopically positioned within a second rod and adapted for sliding movement within the first rod, the second rod having at least one aperture formed therein, and further wherein the attachment member includes a substantially cylindrical inner surface attached to the second rod and at least one prong section positioned through the at least one aperture formed in the second rod and contacting the first rod, wherein the inner surface of the collar member contacts and urges the at least one prong section of the attachment member to frictionally engage the first rod when the first plurality of threads on the collar member engages the second plurality of threads on the attachment member, whereby the first rod cannot move within the second rod.

14. The apparatus according to claim 13, wherein a length of the handle member is adjustable by disengaging the first plurality of threads on the collar member from the second plurality of threads on the attachment member, sliding the first rod to a different position within the second rod, and engaging the first plurality of threads on the collar member to the second plurality of threads on the attachment member.

15. The apparatus according to claim 13, wherein the collar member comprises a substantially frusto-conical body.

16. A kit comprising:
(a) a substantially cylindrical elongate handle member having an upper end and a base end opposite the upper end;
(b) an attachment member attached to the handle member;
(c) a collar member having an outer surface and an inner surface, wherein at least a portion of the outer surface is releasably attached to the attachment member; and
(a) at least one indicia member adapted for releasable attachment to the collar member, the at least one indicia member having distinguishing indicia thereon.

17. The kit according to claim 16, wherein the distinguishing indicia comprises at least one selected from the group consisting of a color, an alphanumeric character, and a graphic.

18. The kit according to claim 16, wherein the attachment member comprises a body section and a flange section extending outwardly from the body section, wherein the at least one indicia member is positioned against the flange section when the at least one indicia member is attached to the collar member and the collar member is attached to the attachment member.

19. The kit according to claim 16, wherein the collar member has a substantially frusto-conical hollow body and a first plurality of threads is formed on the outer surface of the collar member, and further wherein the at least one indicia member comprises a first indicia member having a substantially cylindrical hollow body and a second plurality of threads adapted for complementary engagement with the first plurality of threads is formed on the inner surface of the first indicia member, whereby the collar member and the first indicia member can be releasably attached to each other by complementary engagement between the first plurality of threads and the second plurality of threads.

20. The kit according to claim 19, further comprising a second indicia member adapted for releasable attachment to the collar member, the first indicia member and the second indicia member having different distinguishing indicia, and further wherein the first indicia member and the second indicia member can be interchangeably attached to the collar member.
